(19) United States
(12) Patent Application Publication
(10) Pub. No.: US 2025/0258902 A1
(43) Pub. Date: Aug. 14, 2025

(54) CLOUD ARCHITECTURE FOR TRACKING FIELD ENTROPY

(71) Applicant: Micron Technology, Inc., Boise, ID (US)

(72) Inventor: Lance W. Dover, Fair Oaks, CA (US)

(21) Appl. No.: 18/786,369

(22) Filed: Jul. 26, 2024

Related U.S. Application Data
(60) Provisional application No. 63/551,434, filed on Feb. 8, 2024.

(51) Int. Cl. G06F 21/44

(52) U.S. Cl. CPC G06F 21/44

(57) ABSTRACT

Methods, systems, and devices for a cloud architecture for tracking field entropy are described. For instance, a node of a supply chain may provide, to a verification device, a first identity of a device associated with the supply chain (e.g., a semiconductor device, a memory device). The node may also provide, to the verification device, a request for entropy. The verification device may provide, to the node, entropy based on the first identity and the request from the node, where a second identity is derived based on the entropy. The verification device may store the second identity at the verification device and the node may store the second identity at the device.

### CROSS REFERENCE

The present application for patent claims priority to U.S. Patent Application No. 63/551,434 by Dover, entitled “CLOUD ARCHITECTURE FOR TRACKING FIELD ENTROPY,” filed Feb. 8, 2024, which is assigned to the assignee hereof, and which is expressly incorporated by reference in its entirety herein.

### TECHNICAL FIELD

The following relates to one or more systems for memory, including a cloud architecture for tracking field entropy.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a cloud architecture for tracking field entropy in accordance with examples as disclosed herein.

FIG. 2 shows an example of a system that supports a cloud architecture for tracking field entropy in accordance with examples as disclosed herein.

FIG. 3 shows an example of a supply chain hop scheme that supports a cloud architecture for tracking field entropy in accordance with examples as disclosed herein.

FIG. 4 shows a block diagram of a verification device that supports a cloud architecture for tracking field entropy in accordance with examples as disclosed herein.

FIG. 5 shows a block diagram of a node that supports a cloud architecture for tracking field entropy in accordance with examples as disclosed herein.

FIGS. 6 and 7 show flowcharts illustrating a method or methods that support a cloud architecture for tracking field entropy in accordance with examples as disclosed herein.

### DETAILED DESCRIPTION

As a device (e.g., a semiconductor device, a memory device, or some other type of device) is manufactured, the device may be transferred across multiple nodes (e.g., also referred to as hops, phases, steps, in some examples) of a supply chain. For instance, the device may undergo initial manufacturing and may later be provided to a sequence of nodes of the supply chain to undergo additional manufacturing. For each node to ensure that the device provided to the particular node is authentic (e.g., that the device is not a clone, counterfeit), an initial manufacturer of the device may generate and/or store an initial identity at the device (e.g., an initial device identifier (IDevID), a Unique Device Secret (UDS) seed) that each node of the supply chain may then verify with a verification device (e.g., a verifier, a cloud service). For instance, when a node of the supply chain receives a device, the respective node may provide the initial identity of the device to a verification device (e.g., a component or service that is local or within a cloud environment) that may verify that the device is authentic by comparing the initial identity with information, such as a copy of the initial identity stored at the verification device. It should be noted that the verification device may, in some instances, receive the initial identity out of band (e.g., through a secure channel from the manufacturer). In some examples, the initial identity may include a public portion and a secret portion (e.g., the UDS). If an unauthorized external entity is able to obtain the device and retrieve the secret portion of the initial identity, the unauthorized external entity may use the initial identity to clone the device, which may pose a significant security threat.

One technique for increased security may include generating a new identity at one or more of the hops that may be referred to as a local identity (e.g., a local device identifier (LDevID)). For instance, a first node at a first hop of the supply chain may generate a local identity for the device being manufactured after verifying the initial identity with the verification device. The first node may store the local identity at the device. However, if, upon receiving the device being manufactured, a second node at a second hop of the supply chain attempts to verify the local identity with the verification device, the verification device may determine a mismatch, as the verification device may lack sufficient information to generate the local identity from the initial identity.

Techniques described herein provide for the verification device to generate entropy, which may be used by the nodes and the verification device to update an identity of the device being manufactured throughout the supply chain to improve security and reliability of the system. For example, when a first node in the supply chain determines to generate a new, first local identity for a device being manufactured, the first node may transmit a respective request to the verification device to provide first entropy (e.g., field entropy, a random number, or some other random information), and the verification device may provide the first entropy to the first node. The verification device and the first node may each generate the first local identity based on a combination of the initial identity and the first entropy, and the first node may provide the first entropy to the device being manufactured. The device may independently calculate and store the first local identity using the provided first entropy. Subsequently, the device being manufactured may be received at a second node and the second node may provide an indication of the first local identity to the verification device. The verification device may correctly determine that the provided first local identity matches the generated first local identity at the verification device. The process of verifying local identities and generating new local identities based on entropy may continue throughout the remaining nodes of the supply chain, which may support a verification service that is local or cloud-based, and which may improve security across the supply chain.

In addition to applicability in memory systems described herein, techniques for a cloud architecture for tracking field entropy may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by mitigating or preventing unauthorized external entities from cloning a device being manufactured via a utilization of an initial identity.

Features of the disclosure are illustrated and described in the context of systems. Features of the disclosure are further illustrated and described in the context of a supply chain hop scheme and flowcharts.

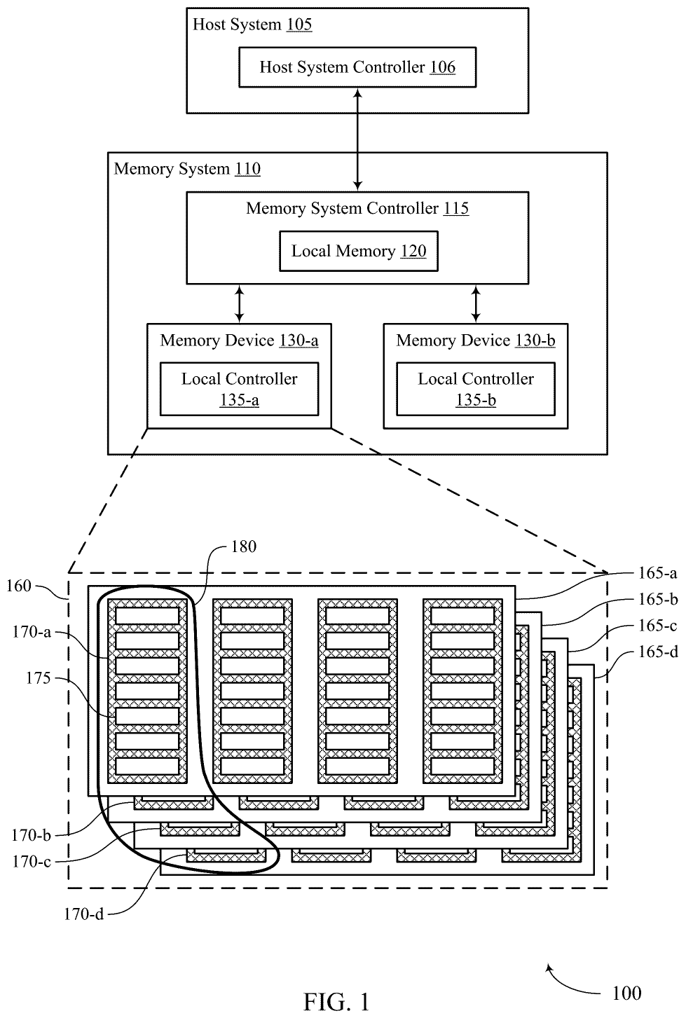

FIG. 1 shows an example of a system 100 that supports a cloud architecture for tracking field entropy in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples, one or more components of FIG. 1 may be manufactured via a supply chain. For instance, memory system 110, memory system controller 115, one or more of memory devices 130-a or 130-b, or a combination thereof may be manufactured over a series of hops of a supply chain. Additionally, or alternatively, the firmware associated with memory devices 130-a or 130-b, or a combination thereof may be modified or updated (e.g., components may be added) at each hop of the supply chain. The techniques described herein may enable a verification device to correctly verify a local identity stored at a device (e.g., a memory system 110, a memory system controller 115, one or more memory devices 130-a or 130-b) at a given hop of a supply chain. When a first node of the given hop determines to generate a new, first local identity, the first node may transmit a respective request to the verification device to provide first entropy (e.g., field entropy, a random number), and the verification device may provide the first entropy to the first node. The verification device and the first node may each generate the first local identity from the initial identity and the first entropy, and the first node may provide the first entropy to the device being manufactured. The device may independently calculate and store the first local identity using the provided first entropy. Then, when the device is received at a second node and the second node provides an indication of the first local identity to the verification device, the verification device may correctly determine that the provided first local identity matches the generated first local identity at the verification device.

If the second node determines to generate a new, second local identity, the second node may transmit a respective request to the verification device to provide second entropy to the second node, and the verification device may provide the second entropy to the second node. The verification device and the second node may each generate the second local identity from the first local identity and the second entropy or may generate the second local identity from the initial identity combined with the first entropy and the second entropy. The second node may provide the second entropy to the device, which may use the second entropy to generate and store the second local identity at the device. The process of verifying local identities and generating local identities may continue throughout the remaining hops of the supply chain.

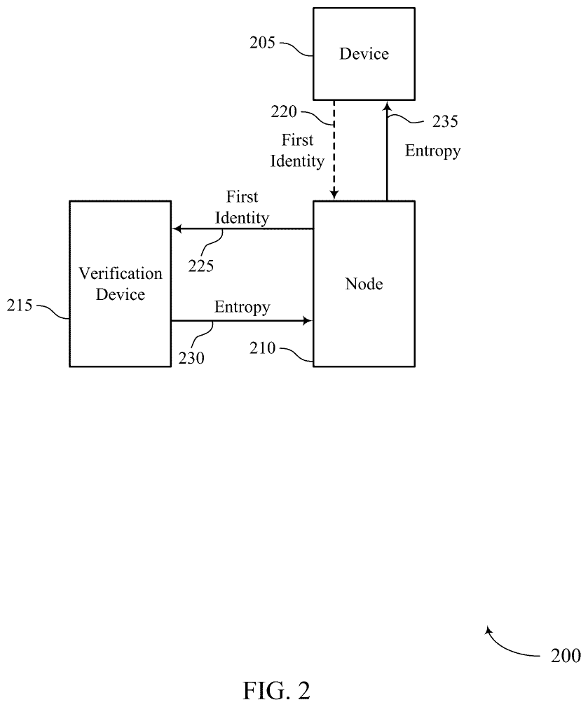

FIG. 2 shows an example of a system 200 that supports a cloud architecture for tracking field entropy in accordance with examples as disclosed herein. The system 200 may implement one or more aspects of a system 100 as described with reference to FIG. 1, or aspects thereof. For instance, device 205 may be an example of a memory system 110, a memory system controller 115, and/or one or more of memory devices 130-a or 130-b as described with reference to FIG. 1. Additionally, or alternatively, the device 205 may be any other type of device. In this example, the device 205 may be in communication with a node 210 of a supply chain associated with manufacture of the device 205.

As depicted in FIG. 2, the device 205 may provide, to the node 210 of the supply chain, an indication 220 of a first identity of the device 205 associated with the supply chain. This first identity, for instance, may be an initial identity (e.g., an identity generated at a first hop of the supply chain subsequent to initial manufacturing) or a local identity (e.g., an identity generated at a previous hop). The node 210 may provide an indication 225 of the first identity to verification device 215. Verification device 215, upon receiving the first identity, may verify that the received first identity matches a copy of the first identity stored or generated at the verification device 215, and may provide an indication that the first identity has been verified to node 210.

Node 210, in response, may transmit a request to generate a second identity (e.g., a new local identity) to the verification device 215. Verification device 215, upon receiving the request, may provide, to the node 210, an indication 230 of entropy that the node 210 and the verification device 215 may use to generate and/or derive the second identity. In some cases, a first portion (e.g., a secret portion, a UDS) of the first identity may be associated with hardware at device 205 and a second portion of the first identity may be associated with previous entropy. In such cases, as part of generating and/or deriving the second identity, the second portion of the first identity may be updated according to the new entropy provided by indication 230. Verification device 215 may store a copy of the second identity and/or the entropy at the verification device 215. Node 210 may send an indication 235 of the entropy to device 205, and device 205 may independently calculate the second identity from the provided entropy and may store the second identity. The entropy may be secret. For example, the entropy may be known to the node 210, the device 205, and the verification device 215, but may not be known to other components or users, including a potential attacker. For example, an attacker may steal a secret portion associated with the identity of the device 205 (e.g., the UDS or other secret portion based on hardware), but may not know the entropy, which may provide for improved security and reduced risk for attacks.

It should be noted that the verification device 215 may be a cloud device. In some examples, a same verification device 215 may be used to generate updated entropy at each hop of the supply chain at which a node 210 requests updated entropy. In other examples, different cloud devices may be used at different hops of the supply chain. In such examples, a first cloud device used to generate first entropy at a given hop of a supply chain may provide the first entropy or a copy of an identity generated from the first entropy to a second cloud device, where the second cloud device may use the first entropy or the copy of the identity to verify a respective identity of the device 205 for a later node of the supply chain and/or to generate second entropy.

In some examples, the node 210 may include the verification device 215 (e.g., the verification device 215 may be local to the node 210). In such examples, the verification device 215 may generate first entropy and may provide the first entropy or a copy of an identity generated from the first entropy to a cloud device or a next verification device associated with a next hop of a supply chain (e.g., a verification device included in a next node of the supply chain). In some examples, the cloud device may be the next verification device or may provide the first entropy or the copy of the identity to the next verification device (e.g., if the verification device is included in the next node or otherwise local to the next node). The next verification device may use the first entropy or the copy of the identity to verify the identity of the device 205 at the next hop and/or to generate a second entropy at the next hop.

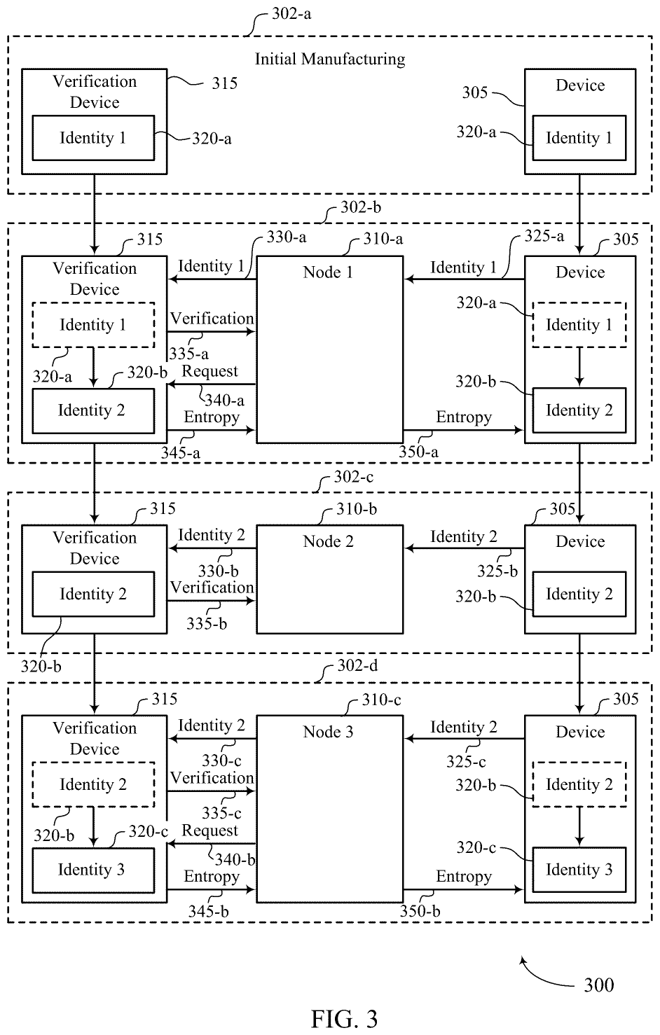

FIG. 3 shows an example of a supply chain hop scheme 300 that supports a cloud architecture for tracking field entropy in accordance with examples as disclosed herein. In some examples, the supply chain hop scheme 300 may implement one or more aspects of systems 100 and/or 200. For instance, device 305 may be an example of a memory system 110, a memory system controller 115, and/or one or more of memory devices 130-a or 130-b as described with reference to FIG. 1 and/or a device 205 as described with reference to FIG. 2; nodes 310-a, 310-b, 310-c may each be an example of a node 210 as described with reference to FIG. 2; and verification device 315 may be an example of a verification device 215 as described with reference to FIG. 2.

During a device's initial manufacturing (e.g., System on a Chip (SoC) manufacturing), which may be labeled as hop 302-a (i.e., Hop 0), an initial identity may be set at device 305 and verification device 315. This initial identity (e.g., an IDevID) may correspond to first identity 320-a (i.e., Identity 1). Hop 302-a may represent a starting point of a supply chain for manufacturing the device 305. In the example of FIG. 3, a hop 302 may represent an example of a phase, step, or portion of a supply chain at which the device 305 may be located. Each hop 302 may be associated with at least one respective node 310, which may be a local computing device, or some other component that may control operations on the device 305 in the respective hop 302.

After initial manufacturing of the device 305 is completed, the device 305 may be provided to a next hop 302-b (i.e., Hop 1) of the supply chain for additional manufacturing (e.g., additional formation, packaging, shipping, or the like). When device 305 is provided to the hop 302-b, a first node 310-a (i.e., Node 1) may initiate a process to verify that the first identity 320-a stored at device 305 matches the first identity 320-a stored at verification device 315. For instance, device 305 may provide an indication 325-a of the identity 320-a to the first node 310-a. After receiving the indication 325-a of the first identity 320-a, first node 310-a may provide an indication 330-a of the first identity 320-a to verification device 315. Verification device 315 may verify that the first identity 320-a stored at verification device 315 matches the first identity 320-a received from the first node 310-a. After performing the verifying, verification device 315 may provide, to first node 310-a, an indication that the first identity 320-a has been verified (e.g., a verification 335-a).

After receiving the verification 335-a, first node 310-a may transmit a request 340-a for entropy (e.g., entropy information, such as a random number). Verification device 315 may generate first entropy and may provide an indication 345-a of the first entropy to first node 310-a. The verification device 315 may, in some examples, use the generated first entropy and the first identity 320-a to generate a second identity 320-b (i.e., Identity 2), where the second identity 320-b may be referred to as a first local identity (e.g., a first LDevID). Verification device 315 may store the second identity 320-b at verification device 315. First node 310-a may generate the second identity 320-b using the first entropy and may provide an indication 350-a of the first entropy to device 305. Device 305 may generate the second identity 320-b from (e.g., based on) the provided first entropy and may store the second identity 320-b. Verification device 315, node 310-a, and device 305 may generate second identity 320-b independently using a common algorithm or process (e.g., an algorithm or process that ensures that second identity 320-b can be generated from the first entropy and/or the first identity 320-a). In some examples, if verification device 315 is unable to verify that the first identity 320-a stored at verification device 315 matches an identifier that is provided to verification device 315 via indication 330-a (e.g., if there is a mismatch), verification device 315 may indicate such mismatch via the verification 335-a and may refrain from generating second identity 320-b and/or providing the corresponding first entropy to first node 310-a.

After the manufacturing associated with hop 302-b is performed, the device 305 may be provided to a next hop 302-c (i.e., Hop 2) of the supply chain for additional manufacturing. When device 305 is provided to the hop 302-c, a second node 310-b (i.e., Node 2) may initiate a process to verify that the second identity 320-b stored at device 305 matches the second identity 320-b stored at verification device 315. For instance, device 305 may provide an indication 325-b of the second identity 320-b to the second node 310-b. After receiving the indication 325-b of the second identity 320-b, second node 310-b may provide an indication 330-b of the second identity 320-b to verification device 315. Verification device 315 may verify that the second identity 320-b stored at verification device 315 matches the second identity 320-b received from the second node 310-b. After performing the verifying, verification device 315 may provide, to second node 310-b, an indication that the second identity 320-b has been verified (e.g., a verification 335-b). In this example, node 310-b may refrain from requesting that the second identity 320-b be updated during the manufacturing associated with hop 302-c. For example, each node 310 may determine whether to update the identity for the device 305 or not.

After the manufacturing associated with hop 302-c is performed, the device may be provided to a next hop 302-d (i.e., Hop 3) of the supply chain for additional manufacturing. When device 305 is provided to the hop 302-d, a third node 310-c (i.e., Node 3) may initiate a process to verify that the second identity 320-b stored at device 305 matches the second identity 320-b stored at verification device 315. For instance, device 305 may provide an indication 325-c of the second identity 320-b to the third node 310-c. After receiving the indication 325-c of the second identity 320-b, third node 310-c may provide an indication 330-c of the second identity 320-b to verification device 315. Verification device 315 may verify that the second identity 320-b a stored at verification device 315 matches the second identity 320-b received from the third node 310-c. After performing the verifying, verification device 315 may provide, to third node 310-c, an indication that the second identity 320-b has been verified (e.g., a verification 335-c).

After receiving the verification 335-c, third node 310-c may transmit a request 340-b for entropy (e.g., entropy information, such as a random number). Verification device 315 may generate second entropy and may provide an indication 345-b of the second entropy to third node 310-c. Verification device 315 may use the generated second entropy and the second identity 320-b to generate a third identity 320-c (i.e., Identity 3), where the second identity 320-b may be referred to as a second local identity (e.g., a second LDevID). Verification device 315 may store the third identity 320-c at verification device 315. Third node 310-c may generate the third identity 320-c using the second entropy and may provide an indication 350-b of the second entropy to device 305. Device 305 may use the second entropy to generate the third identity 320-c and may store the third identity 320-c. Device 305, node 310-c, and the verification device 315 may generate third identity 320-c independently using a common algorithm or process (e.g., an algorithm or process that ensures that third identity 320-c can be generated from the second entropy and/or the second identity 320-b). In some examples, if verification device 315 is unable to verify that the second identity 320-b stored at verification device 315 matches an identifier that is provided to verification device 315 via indication 330-b (e.g., if there is a mismatch), verification device 315 may refrain from generating third identity 320-c and/or providing the corresponding second entropy to third node 310-c.

In some examples, a next identity in the supply chain may be generated based on the immediately previous identity and the most recently generated entropy. For instance, the third identity 320-c may be generated using the second identity 320-b (e.g., the immediately previous identity) and the second entropy generated at the verification device 315 during hop 302-d (e.g., the most recently generated entropy). In other examples, a next identity may be generated based on an IDevID combined with all subsequent supply chain entropy. For example, the third identity 320-c may be generated using the first identity 320-a (e.g., the IDevID) combined with the first entropy generated by verification device 315 at hop 302-b and the second entropy generated by verification device 315.

In some examples, a single verification device 315 may be used as described herein. In other examples, a verification device may be local to a node for at least one node in a supply chain. Additionally, or alternatively, a separate cloud device may be used for verification of at least one node in the supply chain. In such cases where the verification device 315 is included locally in at least one node of the supply chain or is associated with two or more cloud devices, multiple verification devices 315 may be employed. For instance, a first verification device may be used at hop 302-b (i.e., Hop 1) and a second verification device may be used at hop 302-c (i.e., Hop 2). In such examples, the first verification device at hop 302-b may provide an indication of the second identity 320-b (i.e., Identity 2) to the second verification device at hop 302-c (e.g., prior to node 310-b providing an indication 330-b of the second identity 320-b to the second verification device). Alternatively, the first verification device may provide the indication to a device that in turn indicates the second identity 320-b to the second verification device. Similar techniques may be utilized if the hop 302-c and hop 302-d (i.e., Hop 3) each have a separate associated verification device.

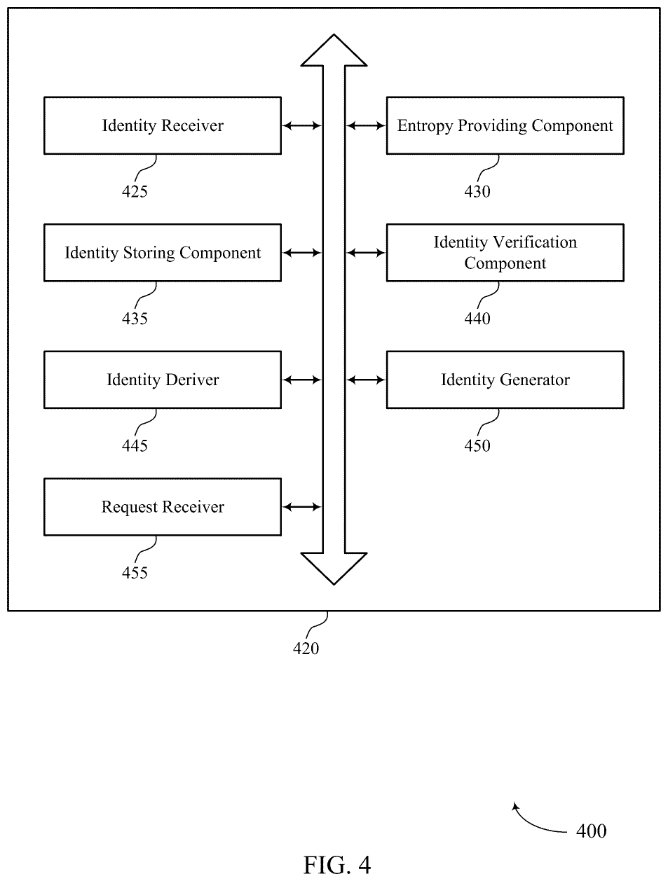

FIG. 4 shows a block diagram 400 of a verification device 420 that supports a cloud architecture for tracking field entropy in accordance with examples as disclosed herein. The verification device 420 may be an example of aspects of a verification device as described with reference to FIGS. 1 through 3. The verification device 420, or various components thereof, may be an example of means for performing various aspects of a cloud architecture for tracking field entropy as described herein. For example, the verification device 420 may include an identity receiver 425, an entropy providing component 430, an identity storing component 435, an identity verification component 440, an identity deriver 445, an identity generator 450, a request receiver 455, or any combination thereof. Each of these components, or components of subcomponents thereof (e.g., one or more processors, one or more memories), may communicate, directly or indirectly, with one another (e.g., via one or more buses).

The identity receiver 425 may be configured as or otherwise support a means for receiving, at a verification device and from a node of a plurality of nodes of a supply chain, a first identity of a device associated with the supply chain. The entropy providing component 430 may be configured as or otherwise support a means for providing, to the node, entropy based on the first identity and a request from the node, where a second identity is derived based on the entropy. The identity storing component 435 may be configured as or otherwise support a means for storing, at the verification device, the second identity.

In some examples, the identity receiver 425 may be configured as or otherwise support a means for receiving, at the verification device and from a second node of the plurality of nodes, an indication of the second identity. In some examples, the identity verification component 440 may be configured as or otherwise support a means for transmitting, to the second node, an indication that the received second identity matches the stored second identity.

In some examples, the request receiver 455 may be configured as or otherwise support a means for receiving, from the second node, a request for updated entropy based on transmitting the indication that the received second identity matches the stored second identity. In some examples, the entropy providing component 430 may be configured as or otherwise support a means for providing, to the second node, the updated entropy based on receiving the request, where a third identity is derived based on the updated entropy. In some examples, the identity storing component 435 may be configured as or otherwise support a means for storing, at the verification device, the third identity.

In some examples, the identity deriver 445 may be configured as or otherwise support a means for deriving, at the verification device and independent from the node, the second identity based on the entropy and the first identity, the second identity used to verify the device in the supply chain.

In some examples, a first portion of the first identity is associated with hardware at the device and a second portion of the first identity is associated with second entropy, and the identity generator 450 may be configured as or otherwise support a means for updating the second portion of the first identity based on the entropy, where the second identity is based on updating the second portion of the first identity.

In some examples, the verification device includes a cloud device.

In some examples, the node includes the verification device.

In some examples, the described functionality of the verification device 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the verification device 420, or various components thereof, may be implemented at least in part by instructions (e.g., stored in memory, non-transitory computer-readable medium) executable by such at least one processor.

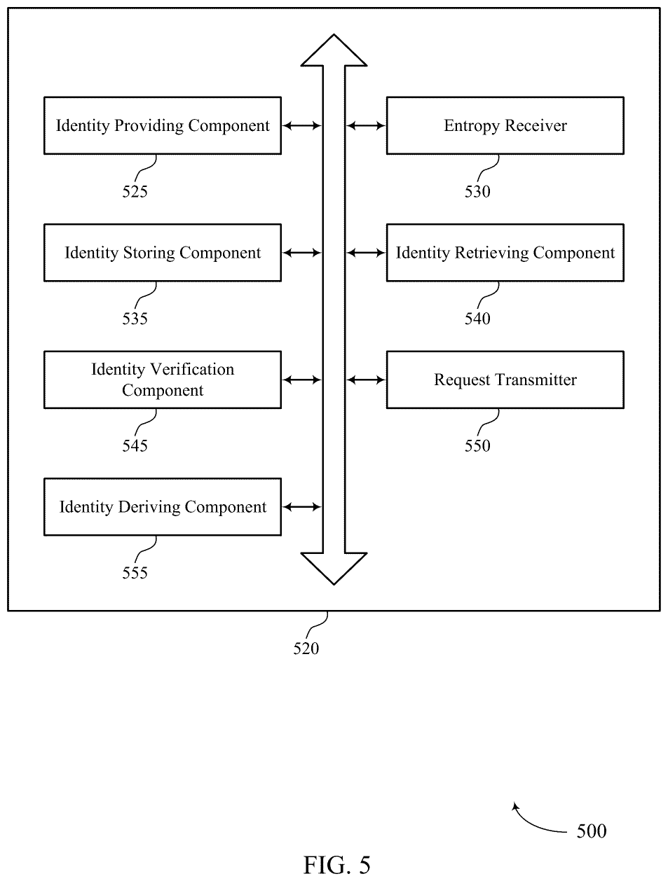

FIG. 5 shows a block diagram 500 of a node 520 that supports a cloud architecture for tracking field entropy in accordance with examples as disclosed herein. The node 520 may be an example of aspects of a node as described with reference to FIGS. 1 through 3. The node 520, or various components thereof, may be an example of means for performing various aspects of a cloud architecture for tracking field entropy as described herein. For example, the node 520 may include an identity providing component 525, an entropy receiver 530, an identity storing component 535, an identity retrieving component 540, an identity verification component 545, a request transmitter 550, an identity deriving component 555, or any combination thereof. Each of these components, or components of subcomponents thereof (e.g., one or more processors, one or more memories), may communicate, directly or indirectly, with one another (e.g., via one or more buses).

The identity providing component 525 may be configured as or otherwise support a means for providing, to a verification device and from the node of the supply chain, a first identity associated with a device of the supply chain. The entropy receiver 530 may be configured as or otherwise support a means for receiving, from the verification device and at the node of the supply chain, entropy used to derive a second identity. The identity storing component 535 may be configured as or otherwise support a means for storing, at the device, the second identity.

In some examples, the identity retrieving component 540 may be configured as or otherwise support a means for retrieving the first identity from the device prior to providing the first identity to the verification device.

In some examples, the identity verification component 545 may be configured as or otherwise support a means for receiving, from the verification device, an indication that the first identity is verified based on providing the first identity to the verification device. In some examples, the request transmitter 550 may be configured as or otherwise support a means for transmitting, to the verification device, a request to generate the second identity based on the first identity being verified, where receiving the entropy is based on transmitting the request.

In some examples, the identity deriving component 555 may be configured as or otherwise support a means for deriving, at the node and independently from the verification device, the second identity based on the first identity and the entropy.

In some examples, a first portion of the first identity is associated with hardware at the device and a second portion of the first identity is associated with second entropy, and the second identity includes an update to the second portion of the first identity based on the entropy.

In some examples, the verification device includes a cloud device.

In some examples, the node includes the verification device.

In some examples, the described functionality of the node 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the node 520, or various components thereof, may be implemented at least in part by instructions (e.g., stored in memory, non-transitory computer-readable medium) executable by such at least one processor.

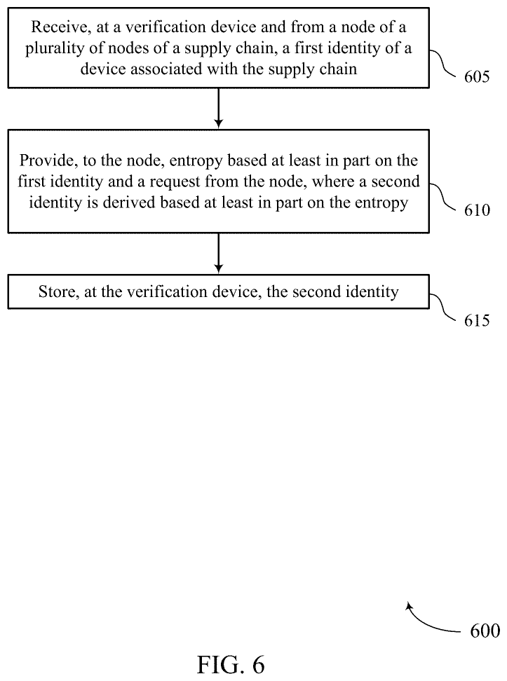

FIG. 6 shows a flowchart illustrating a method 600 that supports a cloud architecture for tracking field entropy in accordance with examples as disclosed herein. The operations of method 600 may be implemented by a verification device or its components as described herein. For example, the operations of method 600 may be performed by a verification device as described with reference to FIGS. 1 through 4. In some examples, a verification device may execute a set of instructions to control the functional elements of the device to perform the described functions. Additionally, or alternatively, the verification device may perform aspects of the described functions using special-purpose hardware.

At 605, the method may include receiving, at a verification device and from a node of a plurality of nodes of a supply chain, a first identity of a device associated with the supply chain. The operations of 605 may be performed in accordance with examples as disclosed herein. For instance, the verification device (e.g., verification device 315 of FIG. 3) may include an identity receiver 425 that receives, from a node (e.g., first node 310-a of FIG. 3) of a plurality of nodes of a supply chain, a first identity (e.g., first identity 320-a of FIG. 3) of a device (e.g., device 305 of FIG. 3) associated with the supply chain—e.g., as described herein, including with reference to the operations described for hop 302-b of FIG. 3 (e.g., receiving an indication 330-a of first identity 320-a at verification device 315).

At 610, the method may include providing, to the node, entropy based on the first identity and a request from the node, where a second identity is derived based on the entropy. The operations of 610 may be performed in accordance with examples as disclosed herein. For instance, the verification device (e.g., verification device 315 of FIG. 3) may include an entropy providing component 430 that provides, to the node (e.g., first node 310-a of FIG. 3), entropy (e.g., indication 345-a of first entropy of FIG. 3) based on the first identity (e.g., first identity 320-a of FIG. 3) and a request (e.g., request 340-a of FIG. 3) from the node, where a second identity (e.g., second identity 320-b of FIG. 3) is derived based on the entropy—e.g., as described herein, including with reference to the operations described for hop 302-b of FIG. 3 (e.g., verification device 315 providing indication 345-a of first entropy after receiving request 340-a from first node 310-a).

At 615, the method may include storing, at the verification device, the second identity, The operations of 615 may be performed in accordance with examples as disclosed herein. For instance, the verification device (e.g., verification device 315 of FIG. 3) may include an identity storing component 435 that stores, at the verification device, the second identity (e.g., second identity 320-b of FIG. 3)—e.g., as described herein, including with reference to the operations described for hop 302-b of FIG. 3 (e.g., storing second identity 320-b at verification device 315).

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a verification device and from a node of a plurality of nodes of a supply chain, a first identity of a device associated with the supply chain; providing, to the node, entropy based on the first identity and a request from the node, where a second identity is derived based on the entropy; and storing, at the verification device, the second identity.

Aspect 2: The method, apparatus, or non-transitory computer-readable medium of aspect 1, further including operations, features, circuitry, logic, means, or instructions, or any combination thereof for receiving, at the verification device and from a second node of the plurality of nodes, an indication of the second identity and transmitting, to the second node, an indication that the received second identity matches the stored second identity.

Aspect 3: The method, apparatus, or non-transitory computer-readable medium of aspect 2, further including operations, features, circuitry, logic, means, or instructions, or any combination thereof for receiving, from the second node, a request for updated entropy based on transmitting the indication that the received second identity matches the stored second identity and providing, to the second node, the updated entropy based on receiving the request, where a third identity is derived based on the updated entropy.

Aspect 4: The method, apparatus, or non-transitory computer-readable medium of aspect 3, further including operations, features, circuitry, logic, means, or instructions, or any combination thereof for storing, at the verification device, the third identity.

Aspect 5: The method, apparatus, or non-transitory computer-readable medium of any of aspects 1 through 4, further including operations, features, circuitry, logic, means, or instructions, or any combination thereof for deriving, at the verification device and independent from the node, the second identity based on the entropy and the first identity, the second identity used to verify the device in the supply chain.

Aspect 6: The method, apparatus, or non-transitory computer-readable medium of any of aspects 1 through 5, where a first portion of the first identity is associated with hardware at the device and a second portion of the first identity is associated with second entropy and the method, apparatuses, and non-transitory computer-readable medium further includes operations, features, circuitry, logic, means, or instructions, or any combination thereof for updating the second portion of the first identity based on the entropy, where the second identity is based on updating the second portion of the first identity.

Aspect 7: The method, apparatus, or non-transitory computer-readable medium of any of aspects 1 through 6, where the verification device includes a cloud device.

Aspect 8: The method, apparatus, or non-transitory computer-readable medium of any of aspects 1 through 7, where the node includes the verification device.

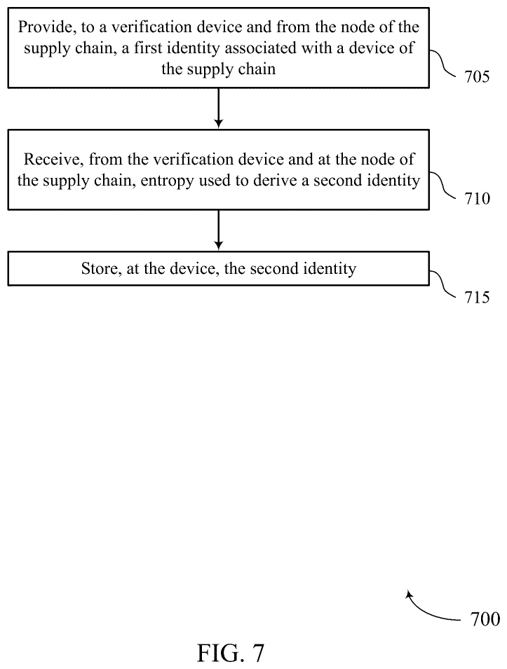

FIG. 7 shows a flowchart illustrating a method 700 that supports a cloud architecture for tracking field entropy in accordance with examples as disclosed herein. The operations of method 700 may be implemented by a node or its components as described herein. For example, the operations of method 700 may be performed by a node as described with reference to FIGS. 1 through 3 and 5. In some examples, a node may execute a set of instructions to control the functional elements of the device to perform the described functions. Additionally, or alternatively, the node may perform aspects of the described functions using special-purpose hardware.

At 705, the method may include providing, to a verification device and from the node of the supply chain, a first identity associated with a device of the supply chain. The operations of 705 may be performed in accordance with examples as disclosed herein. For instance, the node may include an identity providing component 525 that provides, to a verification device (e.g., verification device 315 of FIG. 3) and from the node (e.g., node 310-a of FIG. 3) of the supply chain, a first identity (e.g., first identity 320-a of FIG. 3) associated with a device (e.g., device 305 of FIG. 3) of the supply chain—e.g., as described herein, including with reference to the operations described for hop 302-b of FIG. 3 (e.g., providing indication 325-a of first identity 320-a to first node 310-a from device 305).

At 710, the method may include receiving, from the verification device and at the node of the supply chain, entropy used to derive a second identity. The operations of 710 may be performed in accordance with examples as disclosed herein. For instance, the node (e.g., node 310-a of FIG. 3) may include an entropy receiver 530 that receives, from the verification device (e.g., verification device 315 of FIG. 3) and at the node of the supply chain, entropy (e.g., indication 345-a of first entropy of FIG. 3) used to derive a second identity (e.g., identity 320-b of FIG. 3)—e.g., as described herein, including with reference to the operations described for hop 302-b of FIG. 3 (e.g., receiving indication 345-a of first entropy at first node 310-a).

At 715, the method may include storing, at the device, the second identity. The operations of 715 may be performed in accordance with examples as disclosed herein. For instance, the node (e.g., node 310-a of FIG. 3) may include an identity storing component 535 that stores, at the device (e.g., device 305 of FIG. 3), the second identity (e.g., second identity 320-b of FIG. 3)—e.g., as described herein, including with reference to the operations described for hop 302-b of FIG. 3 (e.g., providing an indication 350-a of second identity 320-b to device 305).

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for providing, to a verification device and from the node of the supply chain, a first identity associated with a device of the supply chain; receiving, from the verification device and at the node of the supply chain, entropy used to derive a second identity; and storing, at the device, the second identity.

Aspect 10: The method, apparatus, or non-transitory computer-readable medium of aspect 9, further including operations, features, circuitry, logic, means, or instructions, or any combination thereof for retrieving the first identity from the device prior to providing the first identity to the verification device.

Aspect 11: The method, apparatus, or non-transitory computer-readable medium of any of aspects 9 through 10, further including operations, features, circuitry, logic, means, or instructions, or any combination thereof for receiving, from the verification device, an indication that the first identity is verified based on providing the first identity to the verification device and transmitting, to the verification device, a request to generate the second identity based on the first identity being verified, where receiving the entropy is based on transmitting the request.

Aspect 12: The method, apparatus, or non-transitory computer-readable medium of any of aspects 9 through 11, further including operations, features, circuitry, logic, means, or instructions, or any combination thereof for deriving, at the node and independently from the verification device, the second identity based on the first identity and the entropy.

Aspect 13: The method, apparatus, or non-transitory computer-readable medium of any of aspects 9 through 12, where a first portion of the first identity is associated with hardware at the device and a second portion of the first identity is associated with second entropy, and the second identity includes an update to the second portion of the first identity based on the entropy.

Aspect 14: The method, apparatus, or non-transitory computer-readable medium of any of aspects 9 through 13, where the verification device includes a cloud device.

Aspect 15: The method, apparatus, or non-transitory computer-readable medium of any of aspects 9 through 14, where the node includes the verification device.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 16: A verification device, including: processing circuitry associated with one or more devices and configured to cause the verification device to: receive, at the verification device and from a node of a plurality of nodes of a supply chain, a first identity of a device associated with the supply chain; provide, to the node, entropy based on the first identity and a request from the node, where a second identity is derived based on the entropy; and store, at the verification device, the second identity.

Aspect 17: The verification device of aspect 16, where the processing circuitry is further configured to cause the verification device to: receive, at the verification device and from a second node of the plurality of nodes, an indication of the second identity; transmit, to the second node, an indication that the received second identity matches the stored second identity.

Aspect 18: The verification device of aspect 17, where the processing circuitry is further configured to cause the verification device to: receive, from the second node, a request for updated entropy based on transmitting the indication that the received second identity matches the stored second identity; provide, to the second node, the updated entropy based on receiving the request, where a third identity is derived based on the updated entropy.

Aspect 19: The verification device of aspect 18, where the processing circuitry is further configured to cause the verification device to: store, at the verification device, the third identity.

Aspect 20: The verification device of any of aspects 16 through 19, where the processing circuitry is further configured to cause the verification device to: derive, at the verification device and independent from the node, the second identity based on the entropy and the first identity, the second identity used to verify the device in the supply chain.

Aspect 21: The verification device of any of aspects 16 through 20, where a first portion of the first identity is associated with hardware at the device and a second portion of the first identity is associated with second entropy, and where the processing circuitry is further configured to: update the second portion of the first identity based on the entropy, where the second identity is based on updating the second portion of the first identity.

Aspect 22: The verification device of any of aspects 16 through 21, where the verification device includes a cloud device.

Aspect 23: The verification device of any of aspects 16 through 22, where the node includes the verification device.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, at a verification device and from a node of a plurality of nodes of a supply chain, a first identity of a device associated with the supply chain;
providing, to the node, entropy based on the first identity and a request from the node, wherein a second identity is derived based on the entropy; and
storing, at the verification device, the second identity.

2. The method of claim 1, further comprising:
receiving, at the verification device and from a second node of the plurality of nodes, an indication of the second identity; and
transmitting, to the second node, an indication that the received second identity matches the stored second identity.

3. The method of claim 2, further comprising:
receiving, from the second node, a request for updated entropy based on transmitting the indication that the received second identity matches the stored second identity; and
providing, to the second node, the updated entropy based on receiving the request, wherein a third identity is derived based on the updated entropy.

4. The method of claim 3, further comprising:
storing, at the verification device, the third identity.

5. The method of claim 1, further comprising:
deriving, at the verification device and independent from the node, the second identity based on the entropy and the first identity, the second identity used to verify the device in the supply chain.

6. The method of claim 1, wherein a first portion of the first identity is associated with hardware at the device and a second portion of the first identity is associated with second entropy, the method further comprising:
updating the second portion of the first identity based on the entropy, wherein the second identity is based on updating the second portion of the first identity.

7. The method of claim 1, wherein the verification device comprises a cloud device.

8. The method of claim 1, wherein the node comprises the verification device.

9. A method at a node of a supply chain, comprising:
providing, to a verification device and from the node of the supply chain, a first identity associated with a device of the supply chain;
receiving, from the verification device and at the node of the supply chain, entropy used to derive a second identity; and
storing, at the device, the second identity.

10. The method of claim 9, further comprising:
retrieving the first identity from the device prior to providing the first identity to the verification device.

11. The method of claim 9, further comprising:
receiving, from the verification device, an indication that the first identity is verified based on providing the first identity to the verification device; and
transmitting, to the verification device, a request to generate the second identity based on the first identity being verified, wherein receiving the entropy is based on transmitting the request.

12. The method of claim 9, further comprising:
deriving, at the node and independently from the verification device, the second identity based on the first identity and the entropy.

13. The method of claim 9, wherein a first portion of the first identity is associated with hardware at the device and a second portion of the first identity is associated with second entropy, and the second identity comprises an update to the second portion of the first identity based on the entropy.

14. The method of claim 9, wherein the verification device comprises a cloud device.

15. The method of claim 9, wherein the node comprises the verification device.

16. A verification device, comprising:
processing circuitry associated with one or more devices and configured to cause the verification device to:
receive, at the verification device and from a node of a plurality of nodes of a supply chain, a first identity of a device associated with the supply chain;
provide, to the node, entropy based on the first identity and a request from the node, wherein a second identity is derived based on the entropy; and
store, at the verification device, the second identity.

17. The verification device of claim 16, wherein the processing circuitry is further configured to cause the verification device to:
receive, at the verification device and from a second node of the plurality of nodes, an indication of the second identity; and
transmit, to the second node, an indication that the received second identity matches the stored second identity.

18. The verification device of claim 17, wherein the processing circuitry is further configured to cause the verification device to:
receive, from the second node, a request for updated entropy based on transmitting the indication that the received second identity matches the stored second identity; and
provide, to the second node, the updated entropy based on receiving the request, wherein a third identity is derived based on the updated entropy.

19. The verification device of claim 18, wherein the processing circuitry is further configured to cause the verification device to:
store, at the verification device, the third identity.

20. The verification device of claim 16, wherein the processing circuitry is further configured to cause the verification device to:
derive, at the verification device and independent from the node, the second identity based on the entropy and the first identity, the second identity used to verify the device in the supply chain.

21. The verification device of claim 16, wherein a first portion of the first identity is associated with hardware at the device and a second portion of the first identity is associated with second entropy, and wherein the processing circuitry is further configured to:
update the second portion of the first identity based on the entropy, wherein the second identity is based on updating the second portion of the first identity.

22. The verification device of claim 16, wherein the verification device comprises a cloud device.

23. The verification device of claim 16, wherein the node comprises the verification device.
